(19) United States
(12) Patent Application Publication
(10) Pub. No.: US 2025/0110065 A1
(43) Pub. Date: Apr. 3, 2025

(54) System to Assess Golf ball quality using multiple orientations of x-ray sources and sensors

(71) Applicant: Guilherme Cardoso, Carlsbad, CA (US)

(72) Inventor: Guilherme Cardoso, Carlsbad, CA (US)

(21) Appl. No.: 18/906,130

(22) Filed: Oct. 3, 2024

Related U.S. Application Data
(60) Provisional application No. 63/542,210, filed on Oct. 3, 2023.

(51) Int. Cl. G01N 23/04; B07C 5/34; G01N 23/083

(52) U.S. Cl. CPC G01N 23/04; B07C 5/3416; G01N 23/083; G01N 2223/3307; G01N 2223/401

(57) ABSTRACT

A system to assess the quality of golf balls can include a plurality of x-ray sources and a plurality of x-ray sensors rather than a single source or single sensor to increase the throughput of golf balls assessed. Each source and corresponding sensor can be located on a same or on a different plane. A feeder mechanism can drop a golf ball such that the ball passes through a beam of x-rays generated by each x-ray source. An x-ray scan can be generated and passed to an image analysis unit to assess any abnormalities inside the golf ball. A sorting mechanism can then direct the golf ball to an appropriate corresponding output bin.

### PRIOR APPLICATIONS

This application claims the benefit of U.S. Provisional Patent Application Ser. No. 63/542,210, filed 2023 Oct. 3, incorporated herein by reference.

### FIELD OF THE INVENTION

The instant invention relates to x-rays and more particularly to the use of x-rays in the quality assurance and assessment of objects such as golf balls.

### BACKGROUND OF THE INVENTION

X-rays are a powerful tool in the quality assessment of several objects because of the penetrating properties of the x-ray photon. This inspection modality, also called x-ray inspection, allows the imaging of the internal construction of objects. Visual inspection, which uses photons in the visible spectrum, cannot see inside objects because the wavelength of visible photons does not allow them to penetrate matter. As a result, x-ray inspection is a quality assessment modality often used in a wide range of industrial and commercial applications as a means to assess if the object was manufactured within its required tolerances.

However, in the golf ball inspection industry, there are bottlenecks in the prevailing approach, which limit the number of balls that can be inspected per minute. Therefore, there is a need to increase the inspection volume.

The high-volume manufacturing of golf balls requires that the x-ray inspection of these balls must be done at high speed. Throughputs of 30 to 160 balls a minute are not uncommon. Thus, the x-ray inspection must be able to keep up with the volume of the golf ball production line.

The manufacturing of golf balls often requires a series of steps involving the vulcanization of rubber. These rubber cores are also grinded and treated so that they are of an exact size and shape. Modern golf balls can be constructed with several layers and cores, as seen in FIGS. 1 and 2.

FIG. 1 illustrates a cutaway of a golf ball 200 that contains a single inner spherical core 201, which can be made from a polymerized rubber, and a durable outer cover 203, typically made from a urethane plastic. A thin interim layer 202 often called a mantle layer typically made from a resiliently compressible plastic material separates the inner core from the outer cover. The dimpled outer surface 204 of the cover is the only thing visible to the naked eye on a completed ball. The ball can be oriented in space having a particular yaw 205, pitch 206, and roll 207 orientation.

FIG. 2 illustrates a cutaway of a golf ball 210 having a smaller inner core 211, and a thicker mantel layer 212 encased by a cover layer 213. Again, the dimpled outer surface 214 of the cover is the only thing visible on a completed ball.

FIG. 3 shows that a single x-ray source 2 can emit a beam of x-rays 3 along an axis 8. An x-ray sensor 4 can be positioned on the axis a distance D away from the x-ray source and oriented in such a way to capture the beam of x-rays generated from the x-ray source. A golf ball 5 can be positioned between the x-ray source and the x-ray sensor. The golf ball can be located on the axis directly in the path of the beam of x-rays emitted from the x-ray source. An x-ray image 6 of the golf ball can then be generated from the x-rays collected by the sensor, to show a view 7 of the internal structure of the golf ball.

As shown in FIG. 4, the x-ray image 6 of the golf ball 7 can then be analyzed to assess the quality of the golf ball. The x-ray image can show the visible outer cover layer 11, the mantle 12, and the inner core 13 of the golf ball. From the image the center 15 of the ball can be calculated. From the image showing the core, the center 14 of the core can similarly be calculated. The position of the centers can then be compared to determine whether they fall within acceptable tolerances. In a perfectly concentric ball both centers will be located in the same position. However, if the centers are separated by more than an acceptable amount, then the ball will fail this quality assessment. For example, a difference between the centers of about 3 mm will indicate the core is off from its perfect position 16 shown by the dashed circle.

As shown in FIG. 5, another abnormality of the inner core 13 of the golf ball can be detected by measuring the difference between the preferred radius R which spans from the concentric center 18 to the outer surface 19 and the measured radius R′. In a perfectly spherical ball, the preferred radius and the measured radius will be the same. However, if the difference in the radiuses is more than an acceptable amount, then the ball will fail this quality assessment. For example, a difference between the radiuses of about 3 mm will indicate the core has an aspherical protuberance 17 or indentation making the ball unacceptable as to quality.

Among the many features of the ball measured with x-rays include concentricity of the various layers, core, mantle and cover in relation to each other, their eccentricity, radiuses at various angles, diameters, and other manufacturing defects such as voids, cracks, inclusions, and the detection of foreign objects in the ball. Abnormalities in any of these structures can cause the ball to see extremely abnormal flight patterns after being struck.

The proper measurement of concentricity of two spheres (inner and outer cores, for example) requires multiplex-ray images at different angles. At a minimum, two x-ray images are needed, one at 0 degrees and the other by rotating the ball by 90 degrees. These orthogonal inspection planes allow for the calculation of the concentricity by using established mathematical methods.

Since at least two orthogonal images are needed to achieve the three-dimensional (3D) measurement needed to determine the concentricity of two spheres (inner core and mantle, or outer core, for example), the state of the art relies on a robot that first picks up a ball from a chute and exposes it to the x-ray beam. The first image is taken and labeled the 0-degree image. The robot rotates the ball by 90 degrees. A second image is taken and labeled the 90 degree image.

As shown in FIG. 6, a robot arm 44 can pick up the ball 41 using a vacuum cup 46 and hold the ball in a first orientation within the beam 42 of a x-ray source 43. An x-ray sensor 45 collects the x-ray passing through the ball to create a first image. The robot can then rotate the ball 90 degrees before a second image is taken.

The robotic arm 44 secures the golf ball 41 in a static orientation at a particular pitch, yaw, and roll orientation and an image is taken. The robotic arm can then move the golf ball 41 to a different pitch, yaw, and roll orientation for a number of successive images. The robotic arm can then release the golf ball to an unseen sorting mechanism and receive a successive ball.

One of the many methods of calculating concentricity of two spheres is then used to determine the concentricity from the images taken. This calculation is done for the many layers of the golf ball: from inner core to outer cover, and other interim layers. If needed, more images from different angles can be taken by the system as the robot steps through different angles as it rotates the golf ball.

Based on the results obtained, the robot can drop the ball at different locations to classify the quality of the ball based on the parameters measured, imaged, and/or calculated.

The single source/single sensor system described above has a critical bottleneck: the number of balls that can be inspected at a specific amount of time. That bottleneck occurs because the robot needs to rotate the ball to different angles. At each movement of the ball, time must potentially be taken for the ball's position to settle before a good x-ray image can be taken. For this reason, the single source/single sensor x-ray inspection units cannot be used in high throughput operations of more than approximately 40 balls per minute, far less than the optimum current manufacturing throughput of up to 160 balls per minute.

The instant disclosure results from efforts to provide an improved golf ball quality inspection system which addresses one or more of the above problems.

### SUMMARY

The primary and secondary objects of the invention are to provide an improved golf ball quality inspection system. These and other objects are achieved by providing an x-ray based imaging and analysis system using multiple x-ray source and sensor orientations.

In some embodiments there is provided a device comprising a first x-ray source, a first x-ray sensor located to detect x-rays emitted by the first x-ray source wherein the first source and first sensor are separated along a first axis by a first distance, a second x-ray source, a second x-ray sensor located to detect x-rays emitted by the second x-ray source wherein the second source and second sensor are separated along a second axis by a second distance and wherein the first axis and the second axis are angularly separated by a first angle, a golf ball located on said first axis between the first source and the first sensor during a first capture of a first x-ray image, the golf ball being located on the second axis between the second source and the second sensor during a second capture of a second x-ray image; an image analysis unit capable of analyzing the first and second images to create a quality assessment of the ball; and a sorter for sorting the ball into one of a plurality of ball quality statuses in response to the quality assessment.

In some embodiments the ball is immobilized during the first capture and the second capture.

In some embodiments the ball is in motion during the first capture and the second capture.

In some embodiments the ball is the ball free falling under the force of gravity during the first capture and the second capture.

In some embodiments the first angle is substantially 90 degrees.

In some embodiments the first angle is greater than substantially 45 degrees.

In some embodiments the first angle is between substantially 85 degrees and 95 degrees.

In some embodiments the first and second axes are located in a first plane.

In some embodiments the first plane is substantially horizontal.

In some embodiments the first plane is substantially vertical.

In some embodiments the first image reveals a first internal structure of the ball at a first pitch, yaw and roll orientation, the second image reveals a second internal structure of the ball at a second pitch, yaw and roll orientation, and the first pitch, yaw and roll orientation is different from said second pitch, yaw and roll orientation.

In some embodiments the ball rests immobile on a support during both of the scans; and wherein the support is radiolucent.

In some embodiments there is provided a method for determining the quality of a golf ball wherein said method comprises first taking a first x-ray image of the ball in a first orientation relative to an x-ray sensor; second taking a second x-ray image of the ball in a second orientation relative to an x-ray sensor; third analyzing the first x-ray image and the second x-ray image to determine a quality status; and fourth sorting the ball into a location corresponding to the quality status.

In some embodiments the method further comprises moving the ball between said first orientation and the second orientation.

In some embodiments the moving comprises holding the ball with a robot and rotating the ball an angle between the first and second orientations.

In some embodiments the moving comprises holding the ball on a rotatable platter and rotating the ball an angle between the first and second orientations.

In some embodiments the method further comprises the x-ray sensor being a first x-ray sensor, providing a second x-ray sensor wherein the first sensor is oriented at an angle to the second sensor and wherein the first image is taken by the first sensor and the second image is taken by the second sensor.

In some embodiments there is provided a system for assessing the quality of golf balls, said system comprises: a plurality of x-ray sources, a plurality of x-ray sensors, a feeder mechanism, a selector mechanism, and a plurality of outputs.

In some embodiments there is provided a system for assessing the quality of golf balls, said system comprises: a first horizontal plane, a first x-ray source aligned on said horizontal plane, a first x-ray sensor aligned on said horizontal plane, a second x-ray source aligned on said horizontal plane, a second x-ray source aligned on said horizontal plane, a feeder mechanism, a selector mechanism, and a plurality of outputs.

In some embodiments said first x-ray sensor is positioned 90 degrees apart from said second x-ray sensor and said first x-ray source is positioned 90 degrees apart from said second x-ray source.

In some embodiments said first x-ray source is separated by said first x-ray sensor along an axis and said second x-ray source is separated by said second x-ray sensors along an axis.

In some embodiments said feeder mechanism is comprised of a chute to deposit golf balls and a robotic arm to pick up said golf balls.

In some embodiments said feeder mechanism is comprised of a carousel.

In some embodiments said carousel has a plurality of apertures to contain golf balls.

In some embodiments said feeder mechanism is comprised of a chute to deposit golf balls into said apertures in said carousel; said carousel located between said x-ray sources and said x-ray sensors.

In some embodiments said carousel rotates to position said golf ball apertures between said x-ray sources and said x-ray sensors.

In some embodiments said feeder mechanism is comprised of tubing to position said golf balls between said x-ray sources and said x-ray sensors.

In some embodiments said tubing utilizes gravity to drive said golf balls.

In some embodiment said tubing utilizes vacuum to drive said golf balls.

In some embodiments said tubing utilizes air flow to drive said golf balls.

In some embodiments said plurality of outputs are comprised of the group: good, medium, and fail.

In some embodiments said plurality of outputs are comprised of exit holes.

In some embodiments said selector mechanism is comprised of an actuator.

In some embodiments said actuator rotates to direct said golf balls to a correct output.

In some embodiments said actuator is comprised of a moving shaft to direct said golf balls to a correct output.

In some embodiments said selector mechanism is comprised of nozzles which utilize air flow to direct said golf balls to a correct output.

In some embodiments said selector mechanism is comprised of a robotic arm which directs said golf balls to a correct output.

In some embodiments, there is provided a system for assessing the quality of golf balls, said system comprises: a feeder mechanism, a first horizontal plane, a first x-ray source aligned on said first horizontal plane, a first x-ray sensor aligned on said first horizontal plane, a second horizontal plane, a second x-ray sensor aligned on said second horizontal plane, a second x-ray sensor on said second horizontal plane, a selector mechanism, and a plurality of outputs.

In some embodiments said feeder mechanism drops a golf ball above said first horizontal plane.

In some embodiments said x-ray sources and said x-ray sensors take x-ray images of said downward moving golf ball.

In some embodiments said feeder mechanism shoots a golf ball from below the lowest of said horizontal planes.

In some embodiments said x-ray sources and said x-ray sensors take x-ray images of said upward moving golf ball.

In some embodiments said system utilizes software algorithms to deblur x-ray images.

In some embodiments said x-ray sources trigger only when said golf ball enters a field of view.

In some embodiments said x-ray sources and said x-ray sensors move to follow said dropped golf ball.

In some embodiments said system calculates said golf ball's concentricity in flight.

In some embodiments, there is provided a system for assessing the quality of golf balls, said system comprises: a feeder mechanism, a plurality of horizontal planes, a plurality of x-ray sources aligned on said horizontal planes, a plurality of x-ray sensors aligned on said horizontal planes, a selector mechanism, and a plurality of outputs.

The content of the original claims is incorporated herein by reference as summarizing features in one or more exemplary embodiments.

### BRIEF DESCRIPTION OF THE DRAWINGS

FIG. 1 is a prior art diagrammatical partial cut-away perspective illustration of a golf ball having a single core and multiple layers.

FIG. 2 is a prior art diagrammatical partial cut-away perspective illustration of a golf ball having a smaller inner core and an inner mantel.

FIG. 3 is a prior art diagrammatical side view of a device to determine the quality of a golf ball having a single x-ray source, a single x-ray sensor, and a golf ball located between said source and said sensor to produce an x-ray image.

FIG. 4 is a prior art diagrammatical enlarged view of the x-ray image showing a deformity in concentricity in the core of the golf ball.

FIG. 5 is a prior art diagrammatical cross-sectional view of a golf ball core showing an aspherical deformity.

FIG. 6 is a prior art illustrative block diagram of an x-ray golf ball imaging system using a single source and sensor and a ball manipulating robot.

FIG. 7 is an illustrative block diagram of a system to assess the quality of golf balls utilizing a single x-ray source and sensor, a feeder mechanism, a rotatable carrier, a selector mechanism, and a plurality of golf balls.

FIG. 8 is an illustrative block diagram of a system to determine the quality of a golf ball having a single x-ray source, a single x-ray sensor, and a golf ball supported by a rotatable platter.

FIG. 9 is a diagrammatical side view of a system to determine the quality of a golf ball having two x-ray sources on two separate horizontal planes, two x-ray sensors on two separate horizontal planes, and a golf ball dropped from above the first horizontal plane.

FIG. 10 is a diagrammatical side view of a system to determine the quality of a golf ball having two x-ray sources on two separate horizontal planes, two x-ray sensors on two separate horizontal planes, and a golf ball dropped from above the first horizontal plane wherein said x-ray sources and said x-ray sensors are rotatively skewed about an angle.

FIG. 11 is a flow chart diagram of a method for determining the quality of a golf ball according to an exemplary embodiment of the invention.

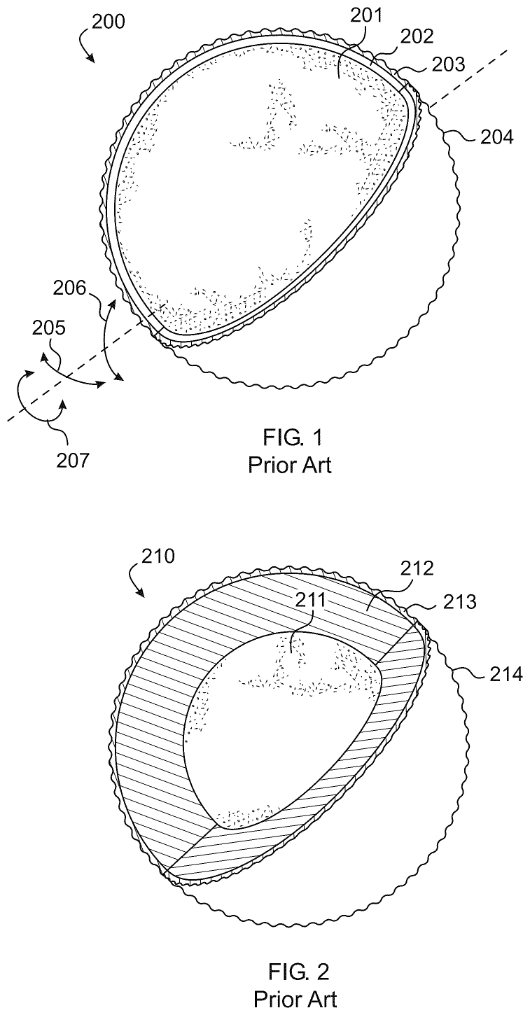

### DESCRIPTION OF THE EXEMPLARY EMBODIMENTS

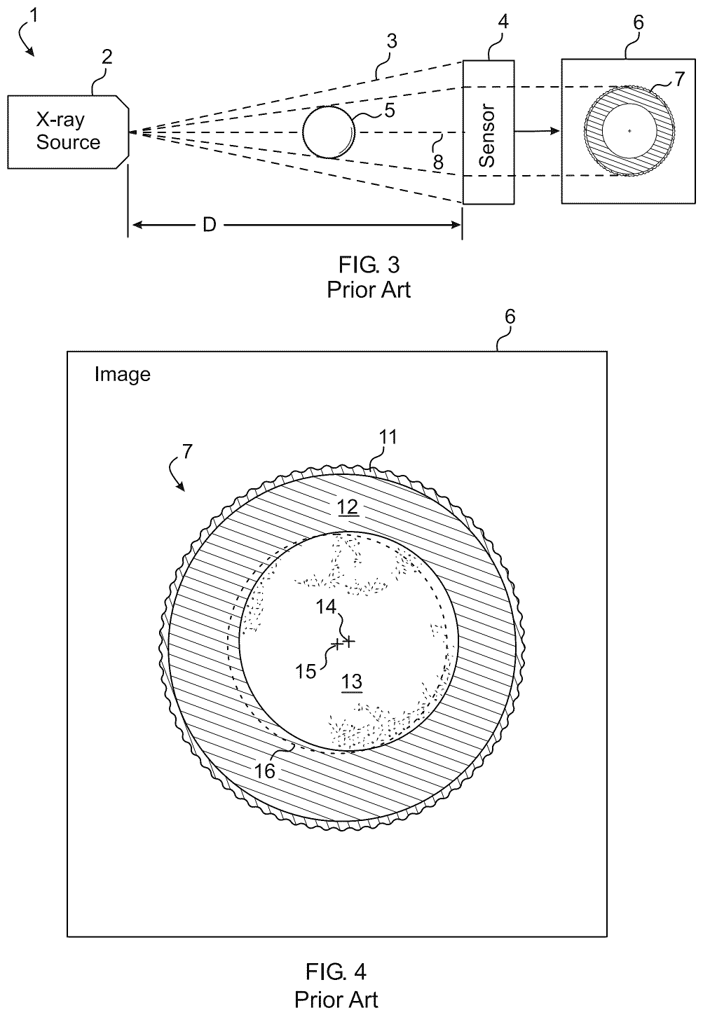

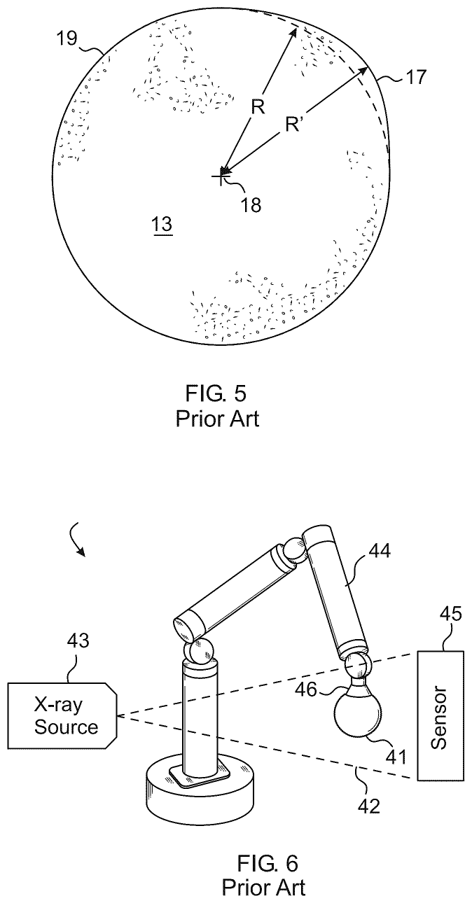

In this specification, the references to top, bottom, upward, downward, upper, lower, vertical, horizontal, sideways, lateral, back, front, proximal, distal, etc. can be used to provide a clear frame of reference for the various structures when the source and sensor are separated in an orientation perpendicular to the force of Earth's gravity as shown in FIG. 3, and not treated as absolutes when the frame of reference is changed, or when the source and sensor are oriented differently.

If used in this specification, the term “substantially” can be used because manufacturing and assembly imprecision and inaccuracies can lead to non-symmetricity and other inexactitudes in the shape, dimensioning and orientation of various structures. Further, use of “substantially” in connection with certain geometrical shapes, such as “triangular”, “wedge-shaped” and “cylindrical”, and orientations, such as “parallel” and “perpendicular”, can be given as a guide to generally describe the function of various structures, and to allow for slight departures from exact mathematical geometrical shapes and orientations, while providing adequately similar function. Those skilled in the art will readily appreciate the degree to which a departure can be made from the mathematically exact geometrical references.

If used in this specification, the word “axial” is meant to refer to directions, movement, or forces acting substantially parallel with or along a respective axis, and not to refer to rotational nor radial nor angular directions, movement or forces, nor torsional forces.

In this specification the units “millimeter” or “millimeters” can be abbreviated “mm”, “centimeter” or “centimeters” can be abbreviated “cm”, and “milligram” or “milligrams” can be abbreviated “mg”. Units of temperature such as “degrees centigrade” can be abbreviated “° C.”.

The following description will describe the exemplary embodiments primarily in connection with golf ball quality assessment. However, those skilled in the art of parts manufacturing will readily appreciate the applicability of the embodiments to other sports articles, consumer products, electro-mechanical devices, and other various types of portable, x-ray penetrable articles of manufacture, that require quality assessment as part of the manufacturing process.

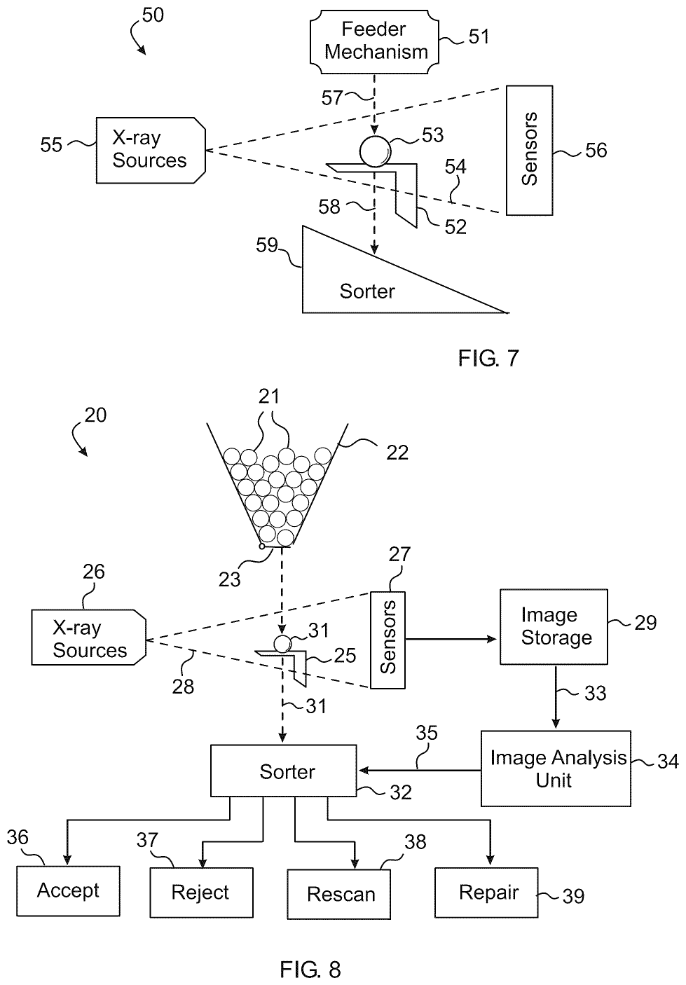

Referring now to the drawing, there is illustrated in FIG. 7 an embodiment of a system to inspect the quality of golf balls, detect abnormalities, and sort the balls into appropriate outputs. The system 50 contains a feeder mechanism 51 which can be located directly vertically above a stage 52 or rotating platter. The stage can be positioned so that it can temporarily secure a golf ball 53 so that a first x-ray beam 54, generated by a first x-ray source 55, can pass through the golf ball 53 and be received by a first x-ray sensor 56. Successive x-ray images can then be taken of the golf ball by additional x-ray sources and sensors. Once the x-ray source 55 and x-ray sensor 56 are done generating x-ray images, the stage 52 can drop 58 the golf ball 53 onto the sorter mechanism 59. In this way, multiple x-ray images at different angles can be taken using without the throughput bottleneck of having to physically rotate or otherwise maneuver the ball.

FIG. 8 an embodiment of a system to inspect the quality of golf balls, detect abnormalities, and sort the balls into appropriate outputs according to their detected quality status. The system 20 can include a first feeder mechanism which includes a hopper 22 containing a plurality of golf balls 21. The hopper can contain a gate 23 to eject a single golf ball 24 onto a stage 25 which immobilizes the ball during an x-ray scanning process. The stage can be located between a plurality of x-ray sources 26 and an x-ray sensors 27. A first beam of x-rays 28 can be emitted from a first x-ray source to pass through the ball and be received by a first sensor in order to create a first image. The first x-ray image can be stored in an image memory unit 29. A second beam of x-rays can then be emitted from a second x-ray source to pass through the ball and be received by a second sensor in order to create a second image. The second x-ray image can be stored in the image memory unit. Successive images can be taken by any number of successive x-ray sources and sensors to collect a desired number of images to determine a quality assessment of the ball. Upon completion of the scan, a gate 31 within the stage opens to drop 31 the ball into a sorter mechanism 32. The images can be sent 33 from the memory unit to an image analysis unit 34 which analyzes the images to calculate a quality assessment of the ball and directs 35 the sorter mechanism to eject the ball into a corresponding bin wherein each bin is associated with one of a plurality of ball quality statuses, namely Accept 36, Reject 37, Rescan 38, and Repair 39. Furthermore, the stage can be partially incorporated into the sorter mechanism by opening the gate at a certain angle so as to direct the ball into the appropriate output bin.

Ultimately, the number of images and the size of angles can be adjusted based on the number of x-ray sources and scanners to capture smaller features on each ball at the expense of throughput.

In this way the quality assessment bottleneck can be avoided by an apparatus made of multiple sources and multiple sensors which can be rotated to various angles to reconstruct a three-dimensional scan used to measure concentricity. This is done instead of taking multiple images from a single imaging system (source and sensor). The apparatus can produce multiple images from multiple imaging systems. Further, the ball does not need to rotate, saving the amount of time needed to achieve a throughput larger than 40 balls per minute.

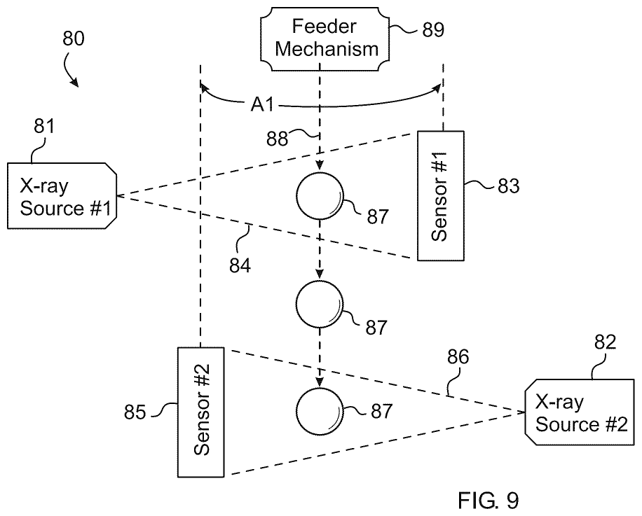

FIG. 9 illustrates another embodiment 80 of a system to assess the quality of golf balls. A first x-ray source 81 can be located on a first substantially horizontal plane vertically above a second x-ray source 82 located on a second substantially horizontal plane substantially parallel with the first plane. A first x-ray sensor 83 can be positioned along a first axis and a first distance away from the first x-ray source, and on the same substantially horizontal plane, and oriented in such a way to capture a first beam 84 of x-rays generated from the first x-ray source. A second x-ray sensor 85 can be positioned on a second substantially horizontal plane below the horizontal plane of the first x-ray source and positioned along a second axis and a second distance away from the second x-ray source, and on the same substantially horizontal plane, and oriented in such a way to capture a second beam of x-rays 86 generated from the x-ray source. The first axis and second axis are separated by a first angle A1. The first angle is typically around 90 degrees but can generally range between substantially 85 degrees and substantially 95 degrees. The first angle should be greater than at least substantially 45 degrees. A golf ball 87 can be dropped from a feeder mechanism (not shown) and accelerate vertically along a path substantially parallel with the vertical axis. The golf ball can fall through the first beam of x-rays and the second beam of x-rays successively in order to generate successive images of the ball in motion while free falling under the force of gravity. Rather than gravity, the ball can be moved through the successive beams using a radiolucent tube and the ball driven pneumatically. Multiple x-ray sources and sensors can be placed on the same horizontal plane as each of them shown.

The positioning of multiple imaging systems on the same horizontal plane may limit how many sources and sensors can be utilized because at some point they will overlap in space. To address this issue, the multiple imaging systems can be positioned on multiple horizontal planes, as shown in FIG. 9.

Since the golf ball must travel past multiple imaging stations, it is possible to consider that the golf ball is dropped from the top or shot from the bottom of the apparatus. As it travels downwards or upwards, each imaging station can take an image of the golf ball as it is within the imaging station's field of view. As the golf ball travels and the images are collected, the measurements can be calculated in flight, so a final result is ready shortly thereafter the ball's travel through the last imaging station.

In the modality where the golf ball 87 is dropped 88 under the force of gravity from a feeder mechanism 89, the ball will be moving through the field of view of the imaging system. Depending on the speeds of the golf ball during image capture, and the pixel size and frame rate of the sensor 83, the x-ray image may be unacceptably blurred. There are numerous strategies to mitigate image blur, a few non-limiting examples being: software algorithms used to deblur images; triggering the x-ray source to emit a strobe-like flash of x-rays when the golf ball is in the field of view; shutter that opens (thus letting x-rays through it) when the golf ball is in the field of view; triggering the sensor to collect a frame of the x-ray image for a brief time when the ball is in the correct position; moving the source/sensor to track the ball; and, providing multiple sensors and sources mounted on a carrousel that tracks the ball as it travels through the apparatus.

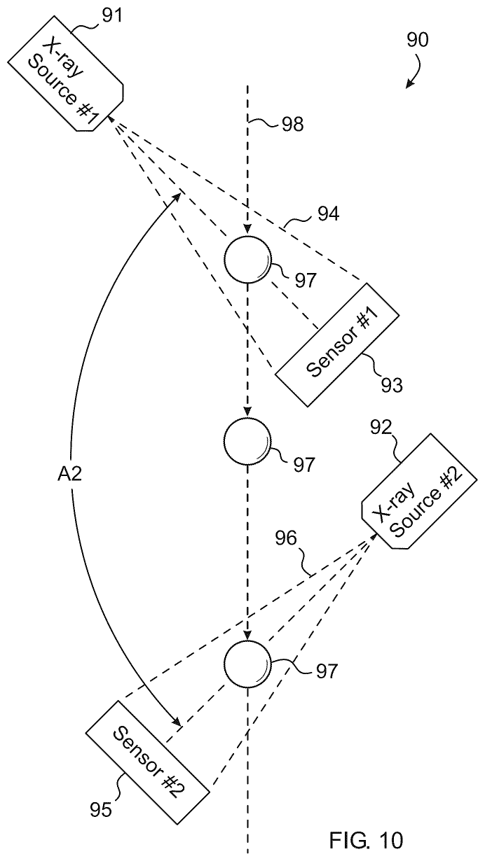

FIG. 10 illustrates another embodiment 90 of a system to assess the quality of golf balls. A first x-ray source 91 can be located on a substantially vertical plane vertically above a second x-ray source 92 located on a second vertical plane substantially parallel to the first vertical plane. The first and second vertical planes can be substantially the same as shown in the drawing A first x-ray sensor 94 can be positioned along a first axis a first distance away from the first x-ray source 81, and on a same plane angled at A2, and oriented in such a way to capture a first beam of x-rays 94 generated from the first x-ray source 81. A second x-ray sensor 95 can be positioned along a second axis on a second horizontal plane below the horizontal plane of the first x-ray source 81 and positioned a second distance away from the second x-ray source 82, and on the same horizontal plane, and oriented in such a way to capture a second beam of x-rays 96 generated from the x-ray source 82. Both axes can be located on the same vertical plane. A golf ball 97 can be dropped from a feeder mechanism (not shown) and accelerate vertically along a path substantially parallel with the vertical axis. The golf ball 87 can fall through the first beam of x-rays 84 and the second beam of x-rays 86 successively. Although the ball may undergo a slight rotation during its fall from the first image position to the second image position, it has been found that such rotation is often within acceptable limits for an adequate quality inspection to occur.

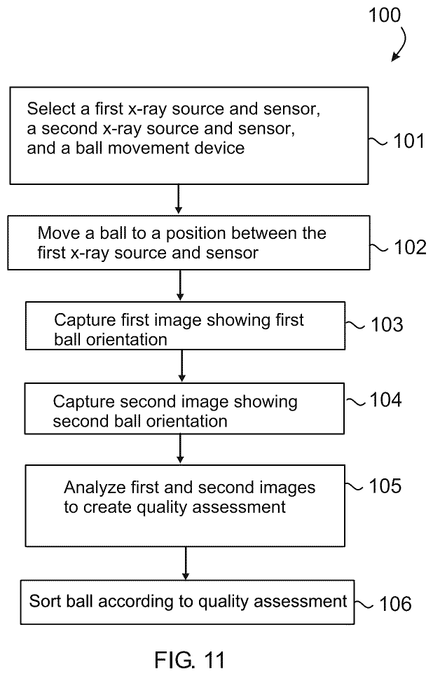

FIG. 11 illustrates a flow chart 100 of the general method to assess the quality of golf balls utilizing the immediate disclosure. First, a first and second x-ray sources and sensors are chosen as well as a ball movement device 101. Second, the ball can be positioned between the first x-ray source and the first x-ray sensor 102. Third, a first image is captured by the first x-ray source and sensor demonstrating a first ball orientation 103. Fourth, a second image is captured by the second x-ray source and sensor demonstrating a second ball orientation 104. Fifth, the first and second images are analyzed to create a quality assessment 105. Finally, the ball is sorted according to the created quality assessment 106.

It should be expressly understood that the above examples of the mechanisms for the Feeder and Selector are only examples, for demonstrating one or more or many possibilities. Therefore, changes and modifications can be made as well as other designs without departing from the spirit and scope of this disclosure.

While the preferred embodiment of the invention has been described, modifications can be made and other embodiments may be devised without departing from the spirit of the invention and the scope of the appended claims.

1. A device comprises:
a first x-ray source;
a first x-ray sensor located to detect x-rays emitted by the first x-ray source;
wherein the first source and first sensor are separated along a first axis by a first distance;
a second x-ray source;
a second x-ray sensor located to detect x-rays emitted by the second x-ray source;
wherein the second source and second sensor are separated along a second axis by a second distance;
wherein the first axis and the second axis are angularly separated by a first angle;
a golf ball located on said first axis between the first source and the first sensor during a first capture of a first x-ray image;
the golf ball being located on the second axis between the second source and the second sensor during a second capture of a second x-ray image;
an image analysis unit capable of analyzing the first and second images to create a quality assessment of the ball; and
a sorter for sorting the ball into one of a plurality of ball quality statuses in response to the quality assessment.

2. The device of claim 1, which further comprises:
The ball being immobilized during the first capture and the second capture.

3. The device of claim 1, which further comprises:
the ball being in motion during the first capture and the second capture.

4. The device of claim 3, which further comprises:
the ball free falling under the force of gravity during the first capture and the second capture.

5. The device of claim 1, which further comprises:
the first angle being substantially 90 degrees.

6. The device of claim 1, which further comprises:
the first angle being greater than substantially 45 degrees.

7. The device of claim 1, which further comprises:
the first angle being between substantially 85 degrees and 95 degrees.

8. The device of claim 1, which further comprises:
the first and second axes are located in a first plane.

9. The device of claim 8, which further comprises:
the first plane being substantially horizontal.

10. The device of claim 8, which further comprises:
the first plane being substantially vertical.

11. The device of claim 1, which further comprises:
wherein the first image reveals a first internal structure of the ball at a first pitch, yaw and roll orientation;
wherein the second image reveals a second internal structure of the ball at a second pitch, yaw and roll orientation; and
wherein the first pitch, yaw and roll orientation is different from said second pitch, yaw and roll orientation.

12. The device of claim 11, which further comprises:
said second pitch, yaw and roll orientation comprising a second yaw angle; and,
wherein said first and second yaw angles differ by between 85 degrees and 95 degrees.

13. The device of claim 1, wherein the ball rests immobile on a support during both of the scans; and wherein the support is radiolucent.

14. A method for determining the quality of a golf ball, said method comprises:
first taking a first x-ray image of the ball in a first orientation relative to an x-ray sensor;
second taking a second x-ray image of the ball in a second orientation relative to an x-ray sensor;
analyzing the first x-ray image and the second x-ray image to determine a quality status;
sorting the ball into a location corresponding to the quality status.

15. The method of claim 14 which further comprises:
moving the ball between said first orientation and the second orientation.

16. The method of claim 15 wherein the moving comprises:
holding the ball with a robot;
rotating the ball an angle between the first and second orientations.

17. The method of claim 15 wherein the moving comprises:
holding the ball on a rotatable platter;
rotating the ball an angle between the first and second orientations.

18. The method of claim 14 which further comprises:
the x-ray sensor being a first x-ray sensor;
providing a second x-ray sensor;
wherein the first sensor is oriented at an angle to the second sensor;
wherein the first image is taken by the first sensor and the second image is taken by the second sensor.
